(19) United States
(12) Patent Application Publication
(10) Pub. No.: US 2021/0121990 A1
(43) Pub. Date: Apr. 29, 2021

(54) DISPENSING APPARATUS

(71) Applicant: Eberspaecher North America Inc., BRIGHTON, MI (US)

(72) Inventor: Stephen P. Stouffer, Fowlerville, MI (US)

(73) Assignee: Eberspaecher North America Inc.

(21) Appl. No.: 16/662,395

(22) Filed: Oct. 24, 2019

(51) Int. Cl. B23K 35/02

(52) U.S. Cl. CPC B23K 35/0255

(57) ABSTRACT

A dispensing apparatus includes a dispensing tube, a lower actuator, and an upper actuator. The dispensing tube includes a tube wall having a constant cross-section along an axis and an upper-actuator bore extending through the tube wall transverse to the axis. The lower actuator includes a lower-actuator housing fixed relative to the dispensing tube and a lower-actuator pin movable linearly relative to the lower-actuator housing between a retracted position and an extended position. The lower-actuator pin in the extended position intersects a centroid of the cross-section of the tube wall. The upper actuator includes an upper-actuator housing fixed relative to the dispensing tube and an upper-actuator pin movable linearly relative to the upper-actuator housing between a retracted position and an extended position. The upper-actuator housing is disposed above the lower-actuator housing, and the upper-actuator pin in the extended position extends through the upper-actuator bore.

### BACKGROUND

Welding is a process to join two components, often made of metal, together by using high heat to melt the components and then allowing the components to cool, which fuses the components together. Welding can use various energy sources to melt the components, including a gas flame. A robotic or manually operated welding machine typically includes a welding tip to control and direct a weld wire. Over time and depending on the pattern of use of the welding machine, welding tips can wear out, such as by becoming deformed.

### BRIEF DESCRIPTION OF THE DRAWINGS

FIG. 1 is a perspective view of a dispensing apparatus.

FIG. 2 is a front view of a housing of the dispensing apparatus with a door open.

FIG. 3A is a side cross-sectional view of a dispensing tube of the dispensing apparatus with a lower-actuator pin in an extended position and an upper-actuator pin in an extended position.

FIG. 3B is a side cross-sectional view of the dispensing tube with the lower-actuator pin in a retracted position and the upper-actuator pin in the extended position.

FIG. 3C is a side cross-sectional view of the dispensing tube with the lower-actuator pin in the extended position and the upper-actuator pin in the extended position.

FIG. 3D is a side cross-sectional view of the dispensing tube with the lower-actuator pin in the extended position and the upper-actuator pin in the retracted position.

FIG. 4A is a top cross-sectional view of the dispensing tube with the lower-actuator pin in the extended position.

FIG. 4B is a top cross-sectional view of the dispensing tube with the lower-actuator pin in the retracted position.

FIG. 5 is a block diagram of a control system of the dispensing apparatus.

FIG. 6 is a process flow diagram of an example process for dispensing an item from the dispensing apparatus with one dispensing tube.

FIG. 7 is a process flow diagram of an example process for dispensing an item from the dispensing apparatus with two dispensing tubes.

FIG. 8 is a process flow diagram of an example process for controlling a light of the dispensing apparatus.

### DETAILED DESCRIPTION

With reference to the Figures, a dispensing apparatus 30 includes a first dispensing tube 32, a first lower actuator 38, a first upper actuator 40, a receiving tube 36, a receiving-tube sensor 92, and a controller 100. The first dispensing tube 32 includes a first tube wall 46 having a constant cross-section along a first axis A1 and a first upper-actuator bore 50 extending through the first tube wall 46 transverse to the first axis A1. The cross-section of the first tube wall 46 is sized for the first dispensing tube 32 to hold a single-file stack of substantially identical items 58. The first lower actuator 38 includes a first lower-actuator housing 60 fixed relative to the first dispensing tube 32 and a first lower-actuator pin 68 movable linearly relative to the first lower-actuator housing 60 between a retracted position and an extended position. The first lower-actuator pin 68 in the extended position intersects a centroid of the cross-section of the first tube wall 46, and the first lower-actuator pin 68 in the retracted position is spaced from the centroid. The first upper actuator 40 includes a first upper-actuator housing 62 fixed relative to the first dispensing tube 32 and a first upper-actuator pin 70 movable linearly relative to the first upper-actuator housing 62 between a retracted position and an extended position. The first upper-actuator housing 62 is disposed above the first lower-actuator housing 60, and the first upper-actuator pin 70 in the extended position extends through the first upper-actuator bore 50. The receiving tube 36 is fixed relative to the first dispensing tube 32, and a cross-section of the receiving tube 36 is substantially the same as the cross-section of the first tube wall 46 of the first dispensing tube 32. The receiving-tube sensor 92 is positioned to detect an item 58 passing through the receiving tube 36. The controller 100 is communicatively coupled to the first lower actuator 38, the first upper actuator 40, and the receiving-tube sensor 92. The controller 100 is programmed to instruct the first lower actuator 38 to move the first lower-actuator pin 68 to the retracted position in response to data from the receiving-tube sensor 92 indicating detection of an item 58.

The dispensing apparatus 30 provides a convenient way to control access to the substantially identical items 58. The dispensing apparatus 30 can provide one item 58 from the first dispensing tube 32 in response to receiving one item 58 in the receiving tube 36, thus capping the number of the items 58 freely circulating. This can reduce waste and loss of items 58 compared to unrestricted access to the items 58. The one-to-one exchange can be performed in an automated manner, providing for low cost and overhead. Moreover, the placement of the actuators 38, 40 can permit a convenient and efficient packaging of components. The actuators 38, 40 can also permit a small number of moving components, which can help provide good reliability.

The substantially identical items 58 are typically items that are consumed by use and then replaced. For the purposes of this disclosure, “substantially identical” is defined as consistent in size and shape. For example, the items 58 can be consumable welding components, such as welding tips, as shown in the Figures, or water-jetting tips, spot-welding tips, cones, diffusers, drill bits, etc. A welding tip is generally rotationally symmetric about an axis, and the welding tip has a length along the axis that is multiple times, e.g., approximately three times, as long as a widest diameter perpendicular to the axis. In one example use case, a worker can place one consumed welding tip into the dispensing apparatus 30, and in response, the dispensing apparatus 30 can provide one fresh welding tip.

The dispensing apparatus 30 can be implemented by being tied to a particular manufacturing machine, such as a robotic welding machine. The dispensing apparatus 30 could be mounted on or near the machine to provide items 58 that the machine consumes over time, such as welding tips. Alternatively, multiple dispensing apparatuses 30 can be mounted in a central location in, e.g., a factory environment, with each dispensing apparatus 30 providing a different type of item 58 that is consumed by a machine in the environment. The multiple dispensing apparatuses 30 can be packaged as a single unit.

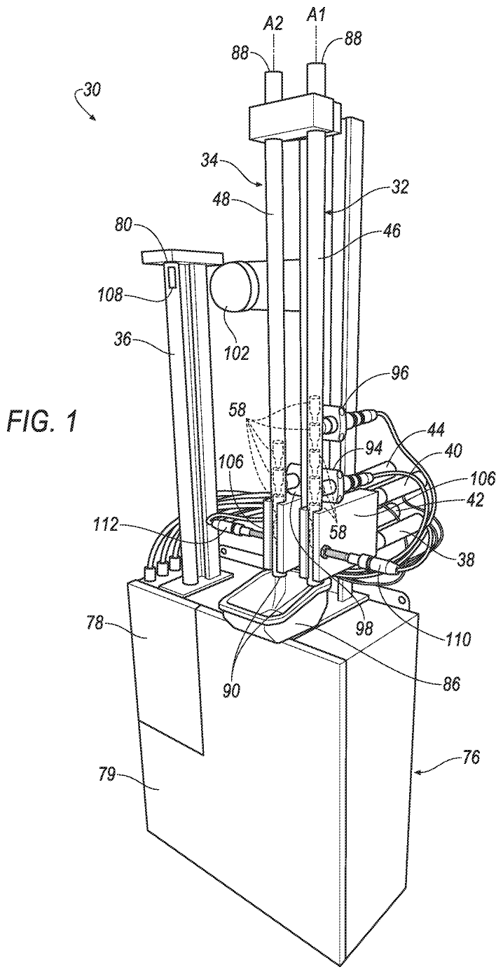

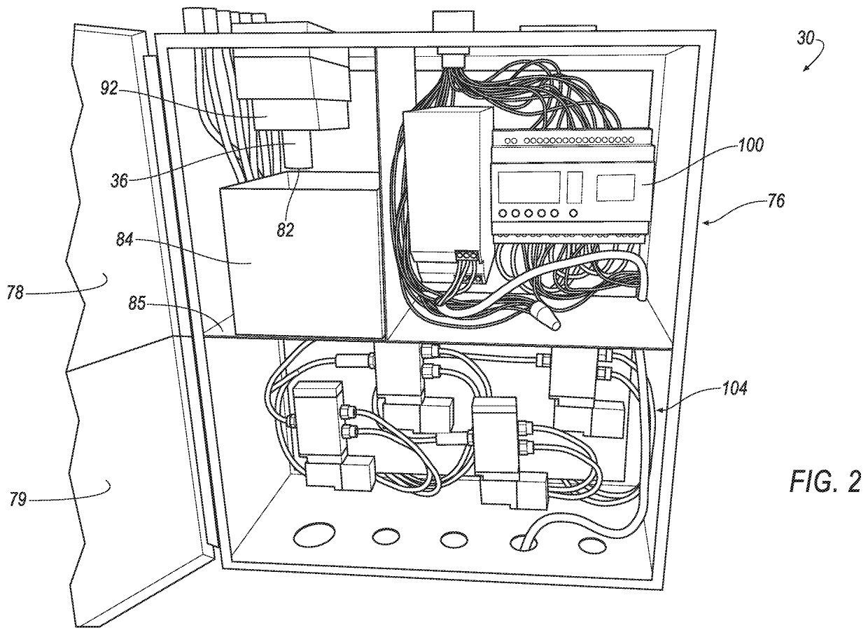

With reference to FIGS. 1 and 2, a housing 76 is provided. The housing 76 can enclose and protect some components of the dispensing apparatus 30. In use, the housing 76 can be fixedly mounted in a workshop, factory floor, etc.

The housing 76 includes a receiving door 78 and a service door 79. The receiving door 78 and the service door 79 are each lockable. The receiving door 78 can be opened to provide access to a receiving receptacle 84, as shown in FIG. 2, and the receiving door 78 can be closed and locked to prevent unauthorized access to the receiving receptacle 84, as shown in FIG. 1. The service door 79 can be opened to provide access to components of the dispensing apparatus 30 that are located inside the housing 76, as shown in FIG. 2, and the service door 79 can be closed and locked to prevent unauthorized access to those components, as shown in FIG. 1. For example, the service door 79 can be opened to service components of the dispensing apparatus 30, and the receiving door 78 can be opened to retrieve the items 58 deposited into the receiving tube 36.

The receiving tube 36 is fixed relative to the housing 76. The receiving tube 36 is elongated from a top end 80 to a bottom end 82. The top end 80 is disposed outside the housing 76, and the bottom end 82 is disposed inside the housing 76. The receiving tube 36 is oriented generally vertically, specifically, is oriented sufficiently close to vertical that an item 58 in the receiving tube 36 at the top end 80 will slide to the bottom end 82. The receiving tube 36 includes a receiving slot 108 positioned near the top end 80 and sized to receive the item 58.

The receiving tube 36 has a constant cross-sectional shape that is elongated from the top end 80 to the bottom end 82. The cross-section of the receiving tube 36 is sized to permit one of the items 58 to pass through, i.e., slide from the top end 80 to the bottom end 82. For example, the cross-section of the receiving tube 36 is substantially the same as the cross-section of the first dispensing tube 32, which is described below. The cross-sectional shape of the receiving tube 36 is sized to permit one of the items 58 to slide down the receiving tube 36. For example, if the item 58 is a welding tip, the cross-section of the receiving tube 36 can be a circular wall with an inner diameter slightly larger than the widest diameter of the welding tip. For another example, the cross-section of the receiving tube 36 can be a rounded rectangle with a length slightly larger than the length of the welding tip and a width slightly larger than the widest diameter of the welding tip; in other words, the cross-section of the receiving tube 36 is sized to receive a horizontally oriented welding tip. The receiving tube 36 can include the receiving slot 108 at the top end 80 into which an item 58 can enter the receiving tube 36 and an opening at the bottom end 82 at which an item 58 can exit the receiving tube 36.

The receiving tube 36 is positioned to drop items 58 passing through the receiving tube 36 into a receiving receptacle 84, shown in FIG. 2. The receiving receptacle 84 is disposed inside the housing 76 directly below the bottom end 82 of the receiving tube 36. The receiving receptacle 84 can be, e.g., a bucket or tray. The receiving receptacle 84 can be removable from the housing 76; e.g., the receiving receptacle 84 can generally sit on a shelf 85 of the housing 76. The receiving receptacle 84 is spaced from the first dispensing tube 32.

The dispensing apparatus 30 includes the first dispensing tube 32 and may include a second dispensing tube 34. The dispensing tubes 32, 34 are each elongated from a top end 88 to a bottom end 90. The dispensing tubes 32, 34 are oriented generally vertically, specifically, are oriented sufficiently close to vertical that a stack of the items 58 will slide downward if unencumbered. The dispensing tubes 32, 34 are mounted to the housing 76 and fixed relative to the housing 76. For example, as shown in the Figures, the dispensing tubes 32, 34 can be mounted on top of the housing 76. Alternatively, the dispensing tubes 32, 34 can be mounted inside the housing 76.

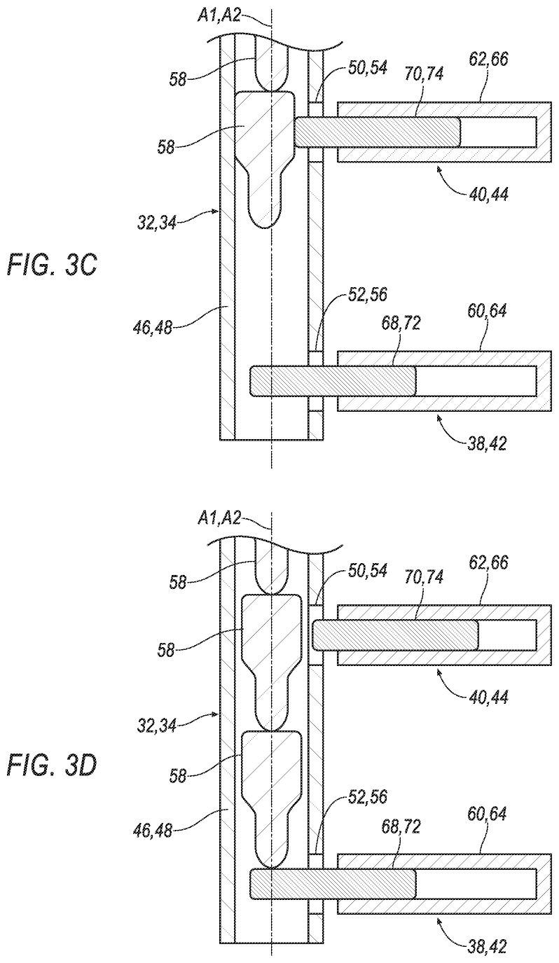

The first dispensing tube 32 includes the first tube wall 46, and the second dispensing tube 34 includes a second tube wall 48. The first tube wall 46 has a constant cross-section elongated along the first axis A1 from the top end 88 to the bottom end 90, and the second tube wall 48 has a constant cross-section elongated along a second axis A2 from the top end 88 to the bottom end 90. The cross-sections of the first and second tube walls 46, 48 are sized for the first and second dispensing tubes 32, 34 to each hold a single-file stack of the items 58, in other words, magazine-style loading of the items 58. For example, if the items 58 are welding tips, the cross-sections of the first and second tube walls 46, 48 can each be a circular wall with an inner diameter slightly larger than the widest diameter of one of the welding tips, as shown in FIGS. 4A-B.

The dispensing tubes 32, 34 are each positioned to drop items 58 from the respective stack of items 58 into a dispensing receptacle 86. The dispensing receptacle 86 is disposed outside the housing 76 directly below both the bottom ends 90 of the dispensing tubes 32, 34. The dispensing receptacle 86 can be, e.g., a bucket or tray. The dispensing receptacle 86 can be removable from the rest of the dispensing apparatus 30. For example, if the dispensing tubes 32, 34 are mounted to a top of the housing 76 as shown in the Figures, the dispensing receptacle 86 can sit on top of the housing 76. For another example, if the dispensing tubes 32, 34 are mounted inside the housing 76, the dispensing receptacle 86 can sit underneath the housing 76 directly below the bottom ends 90 of the dispensing tubes 32, 34.

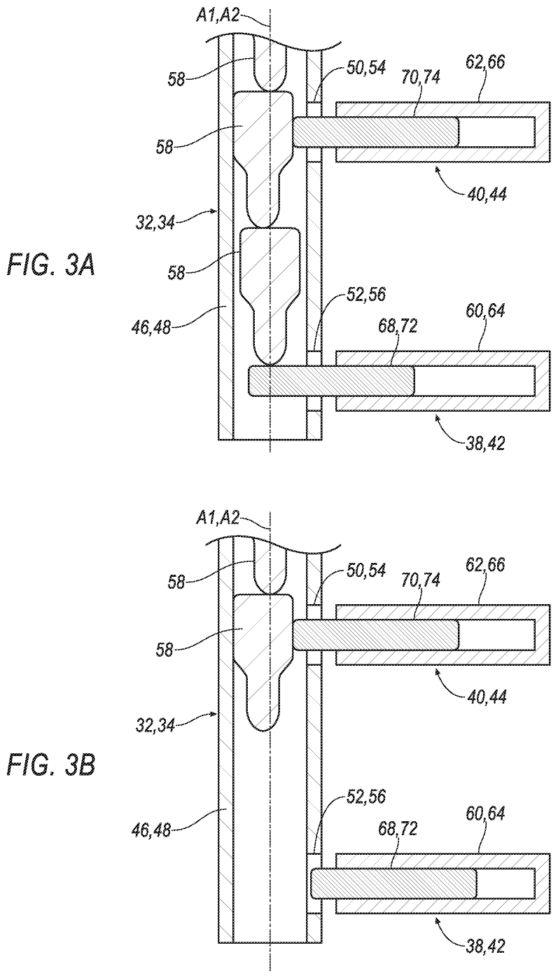

With reference to FIGS. 3A-D, the first dispensing tube 32 includes the first upper-actuator bore 50 and a first lower-actuator bore 52. The first upper-actuator bore 50 and the first lower-actuator bore 52 extend through the first tube wall 46 transverse to the first axis A1; e.g., the first axis A1 extends vertically, and the first upper-actuator bore 50 and the first lower-actuator bore 52 extend horizontally and parallel to each other. The first upper-actuator bore 50 is above the first lower-actuator bore 52 along the first dispensing tube 32. The second dispensing tube 34 includes a second upper-actuator bore 54 and a second lower-actuator bore 56. The second upper-actuator bore 54 and the second lower-actuator bore 56 extend through the second tube wall 48 transverse to the second axis A2; e.g., the second axis A2 extends vertically, and the second upper-actuator bore 54 and the second lower-actuator bore 56 extend horizontally and parallel to each other. The second upper-actuator bore 54 is above the second lower-actuator bore 56 along the second dispensing tube 34. The relative placement of the first actuator bores 50, 52 on the first tube wall 46 can be the same as the relative placement of the second actuator bores 54, 56 on the second tube wall 48. A width, e.g., diameter, of the bores 50, 52, 54, 56 can be slightly larger than a width, e.g., diameter, of a respective one of actuator pins 68, 70, 72, 74 described below.

The dispensing apparatus 30 includes the first lower actuator 38, the first upper actuator 40, a second lower actuator 42, and a second upper actuator 44. Each of the actuators 38, 40, 42, 44 includes an actuator housing 60, 62, 64, 66 and an actuator pin 68, 70, 72, 74: the first lower actuator 38 includes the first lower-actuator housing 60 and the first lower-actuator pin 68, the first upper actuator 40 includes the first upper-actuator housing 62 and the first upper-actuator pin 70, the second lower actuator 42 includes a second lower-actuator housing 64 and a second lower-actuator pin 72, and the second upper actuator 44 includes a second upper-actuator housing 66 and a second upper-actuator pin 74.

Each actuator 38, 40, 42, 44 can be actuated to move the respective actuator pin 68, 70, 72, 74 relative to the respective actuator housing 60, 62, 64, 66. The actuators 38, 40, 42, 44 can be linear actuators, and each actuator pin 68, 70, 72, 74 can be linearly movable relative to the respective actuator housing 60, 62, 64, 66, e.g., linearly movable into and out of the respective actuator housing 60, 62, 64, 66. The actuators 38, 40, 42, 44 can be any suitable type of actuator to produce defined, linear motion, e.g., hydraulic, pneumatic, electric, magnetic, etc. For example, the actuators 38, 40, 42, 44 can be electromechanical solenoids, in which an electromagnetically inductive coil is fixed relative to the respective actuator housing 60, 62, 64, 66 and creates a magnetic field acting on an armature fixed relative to the respective actuator pin 68, 70, 72, 74. The actuator 38, 40, 42, 44 can be actuated by adjusting the magnetic field. For another example, the actuators 38, 40, 42, 44 can be pneumatic. The actuators 38, 40, 42, 44 can include a pneumatic circuit 104, shown in FIG. 2, to deliver compressed gas to the actuator housings 60, 62, 64, 66 to move the respective actuator pins 68, 70, 72, 74 into or out of the respective actuator housings 60, 62, 64, 66. The pneumatic circuit 104 can include tubing and valves to control the flow of compressed gas to the actuator housings 60, 62, 64, 66. The pneumatic circuit 104 can receive the compressed gas from a source external to the dispensing apparatus 30, e.g., a standardized compressed-gas line built into the external environment in which the dispensing apparatus 30 is installed.

Each actuator pin 68, 70, 72, 74 is linearly movable relative to the respective actuator housing 60, 62, 64, 66 between a retracted position and an extended position. The actuator pins 68, 70, 72, 74 in the retracted position are positioned to permit the items 58 to move downward through the respective dispensing tubes 32, 34 past the respective actuator pins 68, 70, 72, 74, as shown in FIG. 3B for the lower-actuator pins 68, 72 and in FIG. 3D for the upper-actuator pins 70, 74. The actuator pins 68, 70, 72, 74 in the retracted position are spaced from a centroid of the cross-section of the respective tube wall 46, 48, as shown in FIG. 4B. A centroid, also called a geometric center, of a plane figure is the arithmetic mean of all the points in the plane figure; informally, the centroid is the point at which the plane figure could be balanced on the tip of a pin. For example, for the circular cross-sections of the tube walls 46, 48 shown in the Figures, the centroid is the center of the circle, i.e., the point from which the radius is measured, which corresponds to the location of the first axis A1 or the second axis A2.

The lower-actuator pins 68, 72 in the extended position extend through the respective lower-actuator bores 52, 56. The lower-actuator pins 68, 72 in the extended position are positioned to block the items 58 from moving downward through the respective dispensing tube, as shown in FIGS. 3A and 3D. Each lower-actuator pin 68, 72 in the extended position serves as a support on which a lowest item 58 of the stack of items 58 sits. The lower-actuator pins 68, 72 in the extended position intersect the centroid of the cross-section of the respective tube wall 46, 48, as shown in FIG. 4A.

The upper-actuator pins 70, 74 in the extended position extend through the respective upper-actuator bores 50, 54. Each upper-actuator pin 70, 74 in the extended position is positioned to press one of the items 58 against the respective tube wall. For example, a distance from a tip of the upper-actuator pin 70, 74 to the directly opposite point on the respective tube wall can be equal to or slightly less than the diameter or width of the item 58 at a point on the item 58 at which the upper-actuator pin 70, 74 contacts the item 58.

The actuator housings 60, 62, 64, 66 are fixed relative to the respective dispensing tubes 32, 34. For example, as shown in FIG. 1, brackets 106 rigidly connect the actuator housings 60, 62, 64, 66 to the respective dispensing tubes 32, 34. The first upper-actuator housing 62 is disposed above the first lower-actuator housing 60, and the second upper-actuator housing 66 is disposed above the second lower-actuator housing 64. Each upper-actuator housing 62, 66 is positioned so that when the respective lower-actuator pin 68, 72 is in the extended position with the lowest item 58 of the stack of items 58 resting on the lower-actuator pin 68, 72, the respective upper-actuator pin 70, 74 in the extended position is positioned to press a second-lowest item 58 of the stack of items 58 against the respective tube wall 46, 48. In particular, the first upper-actuator housing 62 is positioned so that a distance along the first axis A1 from a top of the first lower-actuator pin 68 to a contact point of the first upper-actuator pin 70 is greater than the axial length of the item 58 and less than twice the axial length of the item 58. Likewise, the second upper-actuator housing 66 is positioned so that a distance along the second axis A2 from a top of the second lower-actuator pin 72 to a contact point of the second upper-actuator pin 74 is greater than the axial length of the item 58 and less than twice the axial length of the item 58.

Returning to FIGS. 1 and 2, the dispensing apparatus 30 includes the receiving-tube sensor 92, a lower first-dispensing-tube sensor 94, an upper first-dispensing-tube sensor 96, a second-dispensing-tube sensor 98, a first drop sensor 110, and a second drop sensor 112. The sensors 92, 94, 96, 98, 110, 112 can be any suitable type of sensor for detecting a presence or absence of one of the items 58 in the respective tube. For example, the sensors 92, 94, 96, 98, 110, 112 can be proximity sensors, e.g., capacitive, photoelectric, inductive, ultrasonic, etc.

The receiving-tube sensor 92 is positioned to detect an item 58 passing through the receiving tube 36 into the receiving receptacle 84. The receiving-tube sensor 92 is positioned between the top end 80 and the bottom end 82 of the receiving tube 36 and is positioned inside the housing 76. The lower and upper first-dispensing-tube sensors 94, 96 are positioned to detect items 58 in the first dispensing tube 32. The lower and upper first-dispensing-tube sensors 94, 96 are positioned on the first dispensing tube 32 above the first upper actuator 40, and the upper first-dispensing-tube sensor 96 is positioned above the lower first-dispensing-tube sensor 94. The second-dispensing-tube sensor 98 is positioned to detect items 58 in the second dispensing tube 34 and is positioned on the second dispensing tube 34 above the second upper actuator 44. The first drop sensor 110 is positioned to detect a lowest item 58 of the stack of items 58 in the first dispensing tube 32, and the second drop sensor 112 is positioned to detect a lowest item 58 of the stack of items 58 in the second dispensing tube 34. The first drop sensor 110 is positioned below the lower first-dispensing tube sensor 94, and the second drop sensor 112 is positioned below the second-dispensing-tube sensor 98. The first drop sensor 110 is positioned between the first lower actuator 38 and the first upper actuator 40 along the first axis A1, and the second drop sensor 112 is positioned between the second lower actuator 42 and the second upper actuator 44 along the second axis A2.

The dispensing apparatus 30 includes a light 102. The light 102 may be able to indicate multiple statuses, e.g., three statuses. For example, the light 102 can illuminate in three colors, such as green, yellow, and red. The light 102 may include multiple bulbs corresponding to different statuses or a single bulb that can change status.

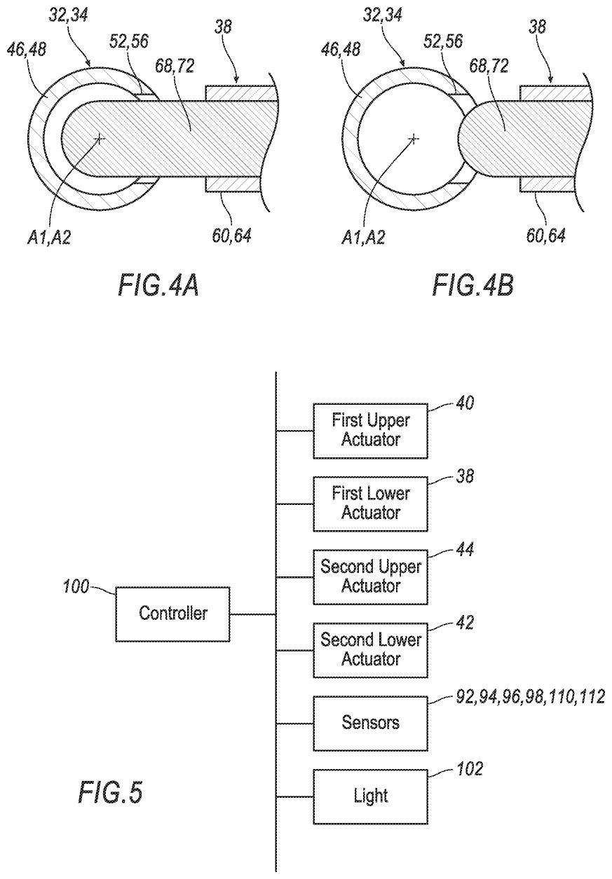

With reference to FIG. 5, the dispensing apparatus 30 includes the controller 100. The controller 100 is a microprocessor-based computing device, e.g., an electronic controller or the like. The controller 100 includes a processor, a memory, etc. The memory of the controller 100 includes media for storing instructions executable by the processor as well as for electronically storing data and/or databases. The controller 100 is communicatively coupled to the actuators 38, 40, 42, 44, the sensors 92, 94, 96, 98, 110, 112, and the light 102, e.g., by wiring or a communications bus.

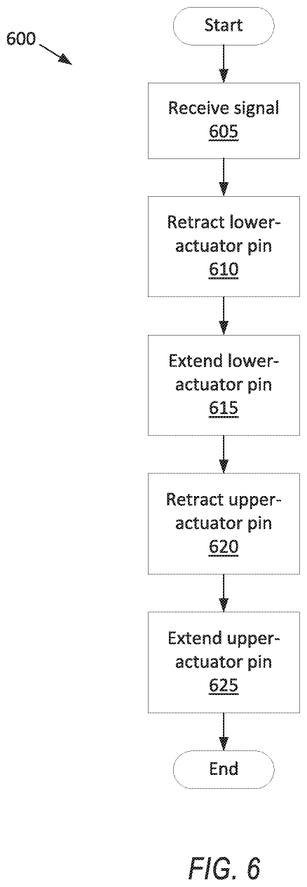

FIG. 6 is a process flow diagram illustrating an exemplary process 600 for dispensing an item 58 from the dispensing apparatus 30 with only the first dispensing tube 32 available. The second dispensing tube 34 may be disabled, or the dispensing apparatus 30 may only include the first dispensing tube 32 and lack the second dispensing tube 34. The memory of the controller 100 stores executable instructions for performing the steps of the process 600. The default state of the dispensing apparatus 30 at the start of the process 600 is for the first lower-actuator pin 68 and the first upper-actuator pin 70 to both be in the extended position, as shown in FIG. 3A. As a general overview of the process 600, in response to a stimulus, namely, data from the receiving-tube sensor 92 indicating that an item 58 entered the receiving receptacle 84, the controller 100 moves the first lower-actuator pin 68 to the retracted position to release a lowest item 58 of the stack of items 58, as shown in FIG. 3B; moves the first lower-actuator pin 68 back to the extended position, as shown in FIG. 3C; moves the first upper-actuator pin 70 to the retracted position to drop the remaining items 58 in the first dispensing tube 32 onto the first lower-actuator pin 68, as shown in FIG. 3D; and moves the first upper-actuator pin 70 back to the extended position, as shown in FIG. 3A.

The process 600 begins in a block 605, in which the controller 100 receives a stimulus. The stimulus can be data from the receiving-tube sensor 92 indicating detection of an item 58. When a user places an item 58, e.g., a spent welding tip, into an opening at the top end 80 of the receiving tube 36, the item 58 slides down the receiving tube 36 through a region in which the receiving-tube sensor 92 detects the item 58 and exits the opening at the bottom end 82 of the receiving tube 36 into the receiving receptacle 84.

Next, in a block 610, the controller 100 instructs the first lower actuator 38 to move the first lower-actuator pin 68 from the extended position to the retracted position while the first upper actuator 40 maintains the first upper-actuator pin 70 in the extended position, as shown in FIG. 3B. The lowest item 58 in the stack of items 58 in the first dispensing tube 32 drops from the first dispensing tube 32 into the dispensing receptacle 86, making the item 58, e.g., a fresh welding tip, available to the user who just placed the old item 58 into the receiving tube 36.

Next, in a block 615, the controller 100 instructs the first lower actuator 38 to move the first lower-actuator pin 68 from the retracted position to the extended position, as shown in FIG. 3C. Moving the first lower-actuator pin 68 to the extended position in this block 615 occurs at a first preset time after moving the first lower-actuator pin 68 to the retracted position in the block 610. The first preset time can be chosen based on a time necessary for the lowest item 58 to drop out of the first dispensing tube 32 and based on a speed at which the first lower actuator 38 can operate, e.g., half a second.

Next, in a block 620, the controller 100 instructs the first upper actuator 40 to move the first upper-actuator pin 70 from the extended position to the retracted position, as shown in FIG. 3D. The remaining items 58 in the stack of items 58 drop down to rest on the first lower-actuator pin 68. Moving the first upper-actuator pin 70 to the retracted position in this block 620 occurs at a second preset time after moving the first lower-actuator pin 68 to the extended position in the block 615. The second preset time can be chosen based on a speed at which the first actuators 38, 40 can operate, e.g., half a second.

Next, in a block 625, the controller 100 instructs the first upper actuator 40 to move the first upper-actuator pin 70 from the retracted position to the extended position, as shown in FIG. 3A. The dispensing apparatus 30 is now back in the default state. Moving the first upper-actuator pin 70 to the extended position in this block 625 occurs at a third preset time after moving the first upper-actuator pin 70 to the retracted position in the block 620. The third preset time can be chosen based on a time necessary for the stack of items 58 to drop onto the first lower-actuator pin 68 and based on a speed at which the first upper actuator 40 can operate, e.g., half a second. After the block 625, the process 600 ends.

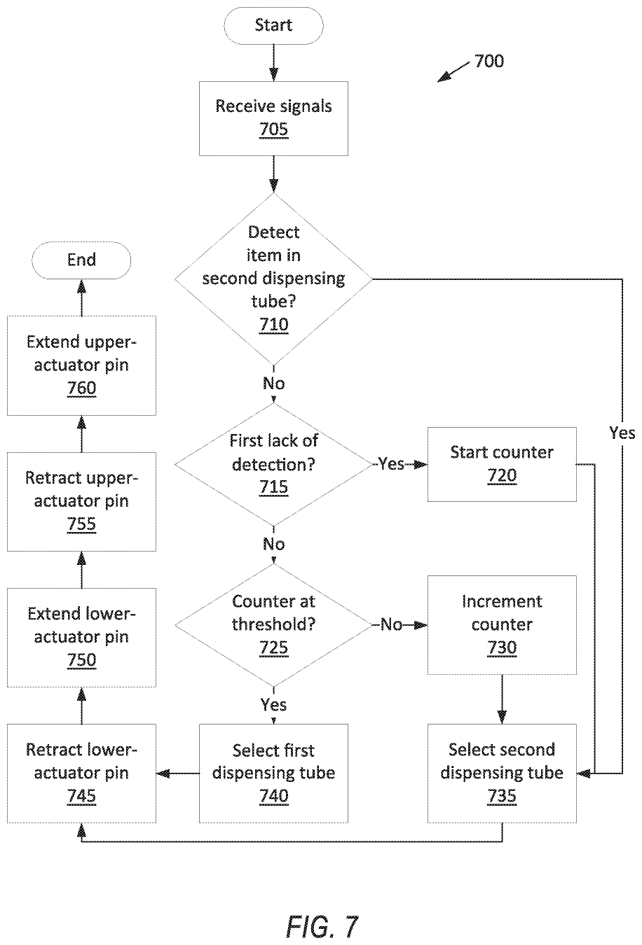

FIG. 7 is a process flow diagram illustrating an exemplary process 700 for dispensing an item 58 from the dispensing apparatus 30 with both dispensing tubes 32, 34 available. The memory of the controller 100 stores executable instructions for performing the steps of the process 700. The default state of the dispensing apparatus 30 at the start of the process 700 is for first lower-actuator pin 68, the first upper-actuator pin 70, the second lower-actuator pin 72, and the second upper-actuator pin 74 to all be in the extended position, as shown in FIG. 3A. As a general overview of the process 700, in response to a stimulus, namely, data from the receiving-tube sensor 92 indicating that an item 58 entered the receiving receptacle 84, the controller 100 chooses whether to dispense an item 58 from the first dispensing tube 32 or the second dispensing tube 34 based on whether items 58 remain in the second dispensing tube 34; and for the chosen dispensing tube 32, 34, moves the lower-actuator pin 68, 72 to the retracted position to release a lowest item 58 of the stack of items 58, moves the lower-actuator pin 68, 72 back to the extended position, moves the upper-actuator pin 70, 74 to the retracted position to drop the remaining items 58 in the dispensing tube 32, 34 onto the lower-actuator pin 68, 72, and moves the upper-actuator pin 70, 74 back to the extended position.

The process 700 begins in a block 705, in which the controller 100 receives data from the sensors 92, 94, 96, 98, 110, 112, including a stimulus. The stimulus can be data from the receiving-tube sensor 92 indicating detection of an item 58. When a user places an item 58, e.g., a spent welding tip, into an opening at the top end 80 of the receiving tube 36, the item 58 slides down the receiving tube 36 through a region in which the receiving-tube sensor 92 detects the item 58 and exits the opening at the bottom end 82 of the receiving tube 36 into the receiving receptacle 84. The controller 100 also receives data from the second-dispensing-tube sensor 98 indicating whether the second-dispensing-tube sensor 98 can detect an item 58 in the second dispensing tube 34.

As an overview of blocks 710-730, the controller 100 determines whether the second dispensing tube 34 contains any items 58 based on the data received from the sensors 92, 94, 96, 98, 110, 112. If any items 58 remain in the second dispensing tube 34, the process 700 proceeds to a block 735. If the second dispensing tube 34 contains no more items 58, the process 700 proceeds to a block 740. Alternatively or additionally to blocks 710-730, the controller 100 can determine whether the second dispensing tube 34 contains any items 58 based on the data received from the second drop sensor 112. If the second drop sensor 112 detects an item 58, the process 700 proceeds to a block 735. If the second drop sensor 112 fails to detect an item 58, the process 700 proceeds to a block 740. If the data from the second drop sensor 112 is used in addition to the blocks 710-730, the controller 100 can produce an error message if the determination based on the data from the second drop sensor 112 leads to a different block than the determinations of the blocks 710-730.

In a decision block 710, the controller 100 determines whether an item 58 is in a position directly in front of the second-dispensing-tube sensor 98 based on the data received from the second-dispensing-tube sensor 98. If the second-dispensing-tube sensor 98 detects an item 58, the process 700 proceeds to a block 730. If the second-dispensing-tube sensor 98 fails to detect an item 58, the process 700 proceeds to a decision block 715.

In the decision block 715, the controller 100 determines whether the failure to detect an item 58 is the first failure to detect an item 58. The controller 100 can check whether a counter has been started in a block 720, e.g., whether a variable in the memory of the controller 100 corresponding to the counter is at zero. For the first failure to detect an item 58, the process 700 proceeds to the block 720. After the first failure to detect an item 58, the process 700 proceeds to a decision block 725.

In the block 720, the controller 100 starts the counter with a value of 1, representing that one failure by the second-dispensing-tube sensor 98 to detect the item 58 has occurred. After the block 720, the process 700 proceeds to a block 735.

In the decision block 725, the controller 100 determines whether the counter is at a threshold value. The threshold value is the number of items 58 that fit in the second dispensing tube 34 at or below where the second-dispensing-tube sensor 98 can detect. For example, with the configuration of the dispensing apparatus 30 shown in FIG. 1, the threshold value is three. If the counter is below the threshold value, the process 700 proceeds to a block 730. If the counter is equal to the threshold value, the process 700 proceeds to a block 740.

In the block 730, the controller 100 increments the counter, i.e., increases the variable representing the counter by 1. After the block 730, the process proceeds to the block 735.

In the block 735, the controller 100 selects the second dispensing tube 34. After the block 735, the process 700 proceeds to a block 745. In the blocks 745-760, the controller 100 is actuating the second lower actuator 42 and the second upper actuator 44, not the first lower actuator 38 or first upper actuator 40.

In the block 740, the controller 100 selects the first dispensing tube 32. After the block 740, the process 700 proceeds to the block 745. In the blocks 745-760, the controller 100 is actuating the first lower actuator 38 and the first upper actuator 40, not the second lower actuator 42 or second upper actuator 44.

In the block 745, the controller 100 instructs the chosen lower actuator 38, 42 to move the corresponding lower-actuator pin 68, 72 from the extended position to the retracted position while the corresponding upper actuator 40, 44 maintains the corresponding upper-actuator pin 70, 74 in the extended position, as shown in FIG. 3B. The lowest item 58 in the stack of items 58 in the chosen dispensing tube 32, 34 drops from the chosen dispensing tube 32, 34 into the dispensing receptacle 86, making the item 58, e.g., a fresh welding tip, available to the user who just placed the old item 58 into the receiving tube 36.

Next, in a block 750, the controller 100 instructs the chosen lower actuator 38, 42 to move the corresponding lower-actuator pin 68, 72 from the retracted position to the extended position, as shown in FIG. 3C. Moving the corresponding lower-actuator pin 68, 72 to the extended position in this block 750 occurs at a first preset time after moving the corresponding lower-actuator pin 68, 72 to the retracted position in the block 745. The first preset time can be chosen based on a time necessary for the lowest item 58 to drop out of the chosen dispensing tube 32, 34 and based on a speed at which the chosen lower actuator 38, 42 can operate, e.g., half a second.

Next, in a block 755, the controller 100 instructs the chosen upper actuator 40, 44 to move the corresponding upper-actuator pin 70, 74 from the extended position to the retracted position, as shown in FIG. 3D. The remaining items 58 in the stack of items 58 drop down to rest on the corresponding lower-actuator pin 68, 72. Moving the corresponding upper-actuator pin 70, 74 to the retracted position in this block 755 occurs at a second preset time after moving the corresponding lower-actuator pin 68, 72 to the extended position in the block 750. The second preset time can be chosen based on a speed at which the chosen actuators 38, 40, 42, 44 can operate, e.g., half a second.

Next, in a block 760, the controller 100 instructs the chosen upper actuator 40, 44 to move the corresponding upper-actuator pin 70, 74 from the retracted position to the extended position, as shown in FIG. 3A. The dispensing apparatus 30 is now back in the default state. Moving the corresponding upper-actuator pin 70, 74 to the extended position in this block 760 occurs at a third preset time after moving the corresponding upper-actuator pin 70, 74 to the retracted position in the block 755. The third preset time can be chosen based on a time necessary for the stack of items 58 to drop onto the corresponding lower-actuator pin 68, 72 and based on a speed at which the chosen upper actuator 40, 44 can operate, e.g., half a second. After the block 760, the process 700 ends.

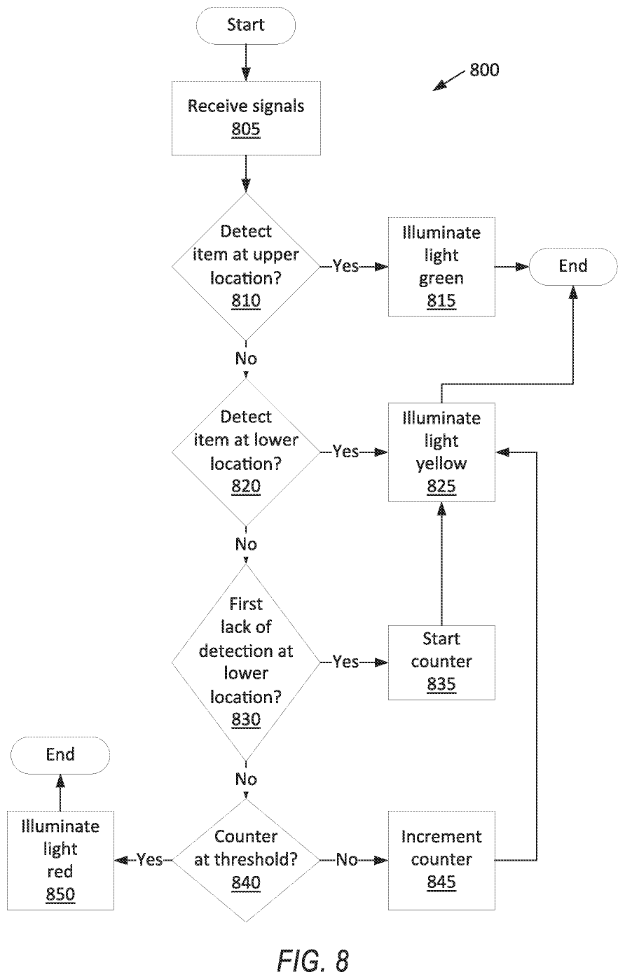

FIG. 8 is a process flow diagram illustrating an exemplary process 800 for controlling the light 102 of the dispensing apparatus 30. The memory of the controller 100 stores executable instructions for performing the steps of the process 800. As a general overview of the process 800, the controller 100 illuminates the light 102 green when the upper first-dispensing-tube sensor 96 detects an item 58; once the upper first-dispensing-tube sensor 96 fails to detect an item 58, illuminates the light 102 yellow when the lower first-dispensing-tube sensor 94 detects an item 58; once the lower first-dispensing-tube sensor 94 fails to detect an item 58, continues to illuminate the light 102 yellow until a counter reaches a threshold value; and once the counter reaches the threshold value, illuminates the light 102 red, indicating that no more items 58 remain.

The process 800 begins in a block 805, in which the controller 100 receives data from the first-dispensing-tube sensors 94, 96. The data indicates whether the first-dispensing-tube sensors 94, 96 detected items 58 at their respective locations.

Next, in a decision block 810, the controller 100 determines whether an item 58 is in a position directly in front of the upper first-dispensing-tube sensor 96 based on the data received from the upper first-dispensing-tube sensor 96. If the upper first-dispensing-tube sensor 96 detects an item 58, the process 800 proceeds to a block 815. If the upper first-dispensing-tube sensor 96 fails to detect an item 58, the process 800 proceeds to a decision block 820.

In the block 815, the controller 100 instructs the light 102 to change the illumination to green. After the block 815, the process 800 ends.

As an overview of blocks 820 and 830-845, the controller 100 determines whether the first dispensing tube 32 contains any items 58 based on the data received from the sensors 92, 94, 96, 98, 110, 112. If any items 58 remain in the first dispensing tube 32, the process 800 proceeds to a block 825. If the first dispensing tube 32 contains no more items 58, the process 800 proceeds to a block 850. Alternatively or additionally to blocks 820 and 830-845, the controller 100 can determine whether the first dispensing tube 32 contains any items 58 based on the data received from the first drop sensor 110. If the first drop sensor 110 detects an item 58, the process 800 proceeds to a block 825. If the first drop sensor 110 fails to detect an item 58, the process 800 proceeds to a block 850. If the data from the first drop sensor 110 is used in addition to the blocks 820 and 830-845, the controller 100 can produce an error message if the determination based on the data from the first drop sensor 110 leads to a different block than the determinations of the blocks 820 and 830-845.

In the decision block 820, the controller 100 determines whether an item 58 is in a position directly in front of the lower first-dispensing-tube sensor 94 based on the data received from the lower first-dispensing-tube sensor 94. If the lower first-dispensing-tube sensor 94 detects an item 58, the process 800 proceeds to a block 825. If the lower first-dispensing-tube sensor 94 fails to detect an item 58, the process 800 proceeds to a decision block 830.

In the block 825, the controller 100 instructs the light 102 to change the illumination to yellow. After the block 825, the process 800 ends.

In the decision block 830, the controller 100 determines whether the failure to detect an item 58 is the first failure to detect an item 58. The controller 100 can check whether a counter has been started in a block 835, e.g., whether a variable in the memory of the controller 100 corresponding to the counter is at zero. For the first failure to detect an item 58, the process 800 proceeds to the block 835. After the first failure to detect an item 58, the process 800 proceeds to a decision block 840.

In the block 835, the controller 100 starts the counter with a value of 1, representing that one failure by the lower first-dispensing-tube sensor 94 to detect the item 58 has occurred. After the block 835, the process 800 proceeds to a block 825.

In the decision block 840, the controller 100 determines whether the counter is at a threshold value. The threshold value is the number of items 58 that fit in the first dispensing tube 32 at or below where the lower first-dispensing-tube sensor 94 can detect. With the configuration of the dispensing apparatus 30 shown in FIG. 1, the threshold value is three. If the counter is below the threshold value, the process 800 proceeds to a block 845. If the counter is equal to the threshold value, the process 800 proceeds to a block 850.

In the block 845, the controller 100 increments the counter, i.e., increases the variable representing the counter by 1. After the block 845, the process proceeds to the block 825.

In the block 850, the controller 100 instructs the light 102 to change the illumination to red. After the block 850, the process 800 ends.

The disclosure has been described in an illustrative manner, and it is to be understood that the terminology which has been used is intended to be in the nature of words of description rather than of limitation. The adjectives “first,” “second,” and “third” are used throughout this document as identifiers and are not intended to signify importance, order, or quantity. “Substantially” as used herein means that a dimension, time duration, shape, or other adjective may vary slightly from what is described due to physical imperfections, power interruptions, variations in machining or other manufacturing, etc. Many modifications and variations of the present disclosure are possible in light of the above teachings, and the disclosure may be practiced otherwise than as specifically described.

1. The dispensing apparatus of claim 20, further comprising:
an upper actuator including an upper-actuator housing fixed relative to the dispensing tube and an upper-actuator pin movable linearly relative to the upper-actuator housing between a retracted position and an extended position, wherein the upper-actuator housing is disposed above the lower-actuator housing, the dispensing tube includes an upper-actuator bore extending through the tube wall transverse to the axis, and the upper-actuator pin in the extended position extends through the upper-actuator bore.

2. The dispensing apparatus of claim 1, wherein
the lower-actuator pin in the extended position is positioned to block the substantially identical items from moving downward through the dispensing tube; and
the lower-actuator pin in the retracted position is positioned to permit the substantially identical items to move downward through the dispensing tube.

3. The dispensing apparatus of claim 2, wherein
the upper-actuator pin in the extended position is positioned to press one of the substantially identical items against the tube wall; and
the upper-actuator pin in the retracted position is positioned to permit the substantially identical items to move downward through the dispensing tube.

4. The dispensing apparatus of claim 3, wherein the upper actuator is positioned so that when the lower-actuator pin is in the extended position with a lowest item of the single-file stack of substantially identical items resting on the lower-actuator pin, the upper-actuator pin in the extended position is positioned to press a second-lowest item of the substantially identical items against the tube wall.

5. The dispensing apparatus of claim 1, wherein the controller is communicatively coupled to the upper actuator, wherein the controller is programmed to, in response to a stimulus, instruct the lower actuator to move the lower-actuator pin to the retracted position while the upper actuator maintains the upper-actuator pin in the extended position.

6. The dispensing apparatus of claim 5, wherein the controller is further programmed to, after instructing the lower actuator to move the lower-actuator pin to the retracted position, instruct the lower actuator to move the lower-actuator pin to the extended position, and then instruct the upper actuator to move the upper-actuator pin to the retracted position.

7. The dispensing apparatus of claim 6, wherein instructing the lower actuator to move the lower-actuator pin to the extended position occurs at a first preset time after instructing the lower actuator to move the lower-actuator pin to the retracted position, and instructing the upper actuator to move the upper-actuator pin to the retracted position occurs at a second preset time after instructing the lower actuator to move the lower-actuator pin to the extended position.

8. The dispensing apparatus of claim 6, wherein the controller is further programmed to, after instructing the upper actuator to move the upper-actuator pin to the retracted position, instruct the upper actuator to move the upper-actuator pin to the extended position.

9. The dispensing apparatus of claim 5, wherein the stimulus is data from the sensor indicating detection of an item.

10. (canceled)

11. (canceled)

12. (canceled)

13. The dispensing apparatus of claim 1, wherein the sensor is a receiving-tube sensor, the dispensing apparatus further comprising a dispensing-tube sensor positioned to detect items in the dispensing tube and positioned above the upper actuator.

14. The dispensing apparatus of claim 13, further comprising a light, wherein the controller is communicatively coupled to the light, and the controller is programmed to change the illumination of the light in response to data from the dispensing-tube sensor.

15. The dispensing apparatus of claim 20, wherein the dispensing tube is oriented substantially vertically.

16. (canceled)

17. The dispensing apparatus of claim 20, wherein the controller is further programmed to instruct the lower actuator to move the lower-actuator pin to the extended position at a preset time after moving the lower-actuator pin to the retracted position.

18. The dispensing apparatus of claim 20, wherein the dispensing tube is positioned to drop items directly into the dispensing receptacle.

19. (canceled)

20. A dispensing apparatus comprising:
a dispensing tube and including a tube wall having a constant cross-section along an axis, wherein the cross-section of the tube wall is sized for the dispensing tube to hold a single-file stack of substantially identical items;
a dispensing receptacle, wherein the dispensing tube is positioned to drop items into the dispensing receptacle;
a lower actuator including a lower-actuator housing fixed relative to the dispensing tube and a lower-actuator pin movable linearly relative to the lower-actuator housing between a retracted position and an extended position, wherein the lower-actuator pin in the extended position intersects a centroid of the cross-section of the tube wall, and the lower-actuator pin in the retracted position is spaced from the centroid;
a receiving tube fixed relative to the dispensing tube, wherein a cross-section of the receiving tube is sized to permit one of the items to pass through;
a receiving receptacle, wherein the receiving tube is positioned to permit one of the items to pass through and then into the receiving receptacle;
a sensor positioned to detect an item passing through the receiving tube; and
a controller communicatively coupled to the sensor and to the lower actuator;
wherein the controller is programmed to instruct the lower actuator to move the lower-actuator pin to the retracted position in response to data from the sensor indicating detection of an item; and
the dispensing apparatus lacks any pathways for the items to travel from the receiving tube to the dispensing receptacle or from the dispensing tube to the receiving receptacle.

21. The dispensing apparatus of claim 20, wherein the dispensing apparatus lacks any pathways for the items to travel from the receiving receptacle to the dispensing receptacle or from the dispensing receptacle to the receiving receptacle.

22. The dispensing apparatus of claim 20, further comprising a housing, wherein the dispensing receptacle is disposed outside the housing, the dispensing tube is mounted to the housing, and the receiving receptacle is disposed inside the housing.

23. The dispensing apparatus of claim 20, wherein the receiving receptacle lacks any bottom outlets.

24. The dispensing apparatus of claim 20, wherein the receiving tube includes a receiving slot, the receiving slot is spaced from the dispensing tube and the dispensing receptacle, and the dispensing apparatus lacks any pathways for the items to travel from the receiving slot of the receiving tube to the dispensing receptacle.

25. The dispensing apparatus of claim 20, wherein the dispensing tube includes a top end, the top end is spaced from the receiving tube and the receiving receptacle, and the dispensing apparatus lacks any pathways for the items to travel from the top end of the dispensing tube to the receiving receptacle.
